(19) United States
(12) Patent Application Publication
(10) Pub. No.: US 2026/0099685 A1
(43) Pub. Date: Apr. 9, 2026

(54) Systems and Methods for Extracting Information for Normalized Data Records from Freeform Documents using Language Models

(71) Applicant: Auditoria.AI, Inc., San Jose, CA (US)

(72) Inventors: Tao Tong, Fremont, CA (US); Lattupally Chandrateja Reddy, Telangana (IN)

(73) Assignee: Auditoria.AI, Inc., San Jose, CA (US)

(21) Appl. No.: 19/346,142

(22) Filed: Sep. 30, 2025

Related U.S. Application Data
(60) Provisional application No. 63/701,384, filed on Sep. 30, 2024.

(51) Int. Cl. G06F 40/40; G06F 40/103; G06V 30/10; G06V 30/413; G06V 30/416; G06V 30/418

(52) U.S. Cl. CPC G06F 40/40; G06F 40/103; G06V 30/10; G06V 30/413; G06V 30/416; G06V 30/418; G06V 2201/09; G06V 2201/10

(57) ABSTRACT

Systems and methods for extracting information from documents using language models are disclosed. In an embodiment, a method includes receiving an input document containing unstructured or semi-structured data, performing document classification by providing a first prompt to a first language model, the first prompt including a section defining document classification parameters, example documents, and the input document, performing format pattern detection by providing a second prompt to a second language model, the second prompt including a section defining format analysis parameters, a list of pre-configured document patterns, and the input document, performing information extraction by providing a third prompt to a third language model, the third prompt including a section defining information extraction parameters, pattern extraction metadata associated with the matched document pattern, a schema specification, and the input document, wherein the third language model outputs a normalized data record according to the schema with field values and confidence scores.

### RELATED APPLICATIONS

This application claims priority to U.S. Provisional Patent Application No. 63/701,384, titled Systems and Methods for Extracting Information for Normalized Data Records from Freeform Documents using Language Models, filed Sep. 30, 2024, which is hereby incorporated by reference in its entirety.

### FIELD OF THE INVENTION

The present invention relates generally to automated data processing, and more specifically to extracting information from documents using LLMs to be normalized and stored as structured data.

### BACKGROUND OF THE INVENTION

In the modern digital business landscape, organizations grapple with an extensive array of complex documents, including invoices, remittances, financial statements, vendor forms, contracts, and regulatory filings. These documents, often containing critical information, require extraction and normalization into structured data to support various business processes, analytics, and decision-making.

Traditional methods of information extraction have been labor-intensive and error-prone. While Optical Character Recognition (OCR) technology has aided in digitizing physical documents, it frequently struggles with complex layouts, handwritten text, and varied document formats.

Recent advancements in Natural Language Processing (NLP) and computer vision have led to the development of large language models (LLMs) capable of understanding and processing text. However, most of these models are primarily designed for text data, limiting their effectiveness when dealing with the multi-modal nature of many business documents, which often include text, tables, images, and graphical elements.

There is a pressing need for a more sophisticated, yet flexible system that can effectively process and extract information from complex, multi-modal business documents, converting unstructured or semi-structured data into normalized, structured records that can be seamlessly integrated into various business systems.

### SUMMARY OF THE INVENTION

Systems and methods for extracting information from documents using language models are disclosed. In an embodiment, a method includes receiving an input document containing unstructured or semi-structured data, performing document classification by providing a first prompt to a first language model, the first prompt including a section defining document classification parameters, example documents, and the input document, performing format pattern detection by providing a second prompt to a second language model, the second prompt including a section defining format analysis parameters, a list of pre-configured document patterns, and the input document, performing information extraction by providing a third prompt to a third language model, the third prompt including a section defining information extraction parameters, pattern extraction metadata associated with the matched document pattern, a schema specification, and the input document, wherein the third language model outputs a normalized data record according to the schema with field values and confidence scores.

### BRIEF DESCRIPTION OF THE DRAWINGS

FIG. 1 illustrates a system for populating a business records database with information extracted from documents in accordance with several embodiments of the invention.

FIG. 2 conceptually illustrates a client device in accordance with several embodiments of the invention.

FIG. 3 conceptually illustrates an integration platform system in accordance with several embodiments of the invention.

FIG. 4 illustrates a process for a training phase and a deployment and monitoring phase of a language model.

FIG. 5 conceptually illustrates a template for constructing a prompt for an LLM in accordance with embodiments of the invention.

FIG. 6 conceptually illustrates a template for constructing a prompt for an LLM in a document classification stage in accordance with some embodiments of the invention.

FIG. 7 conceptually illustrates a template for constructing a prompt for an LLM in a format pattern detection stage in accordance with some embodiments of the invention.

FIG. 8 conceptually illustrates a template for constructing a prompt for an LLM in an information extraction stage in accordance with some embodiments of the invention.

FIG. 9 illustrates a process for information extraction using multiple processing stages in accordance with some embodiments of the invention.

### DETAILED DISCLOSURE OF THE INVENTION

Turning now to the drawings, systems and methods for extracting information from complex, multi-modal documents using large language models (LLMs) or other language models (LM) to generate normalized business records are disclosed. Embodiments of the invention address the challenges of processing diverse document formats and extracting structured information with high accuracy and efficiency. In contrast to traditional OCR processes, multi-page and multi-modal (e.g., text and data) documents of a wide variety of formats (e.g., Excel, Word, PDF, scanned images) can be processed to extract and transform unstructured information into standardized, structured, business records.

Many embodiments of the invention utilize LM functions for any of three processing stages that progressively develop a source document as an information source: (1) “document classification” that determines whether a source document is relevant to the specific business context being addressed, such as financial processes or contract management; (2) “format pattern detection” that identifies structure and layout of the source document, including recognizing common document types like invoices or reports; and (3) “information extraction” that extracts relevant data from the source document based on detected patterns and context, transforming unstructured information into structured data fields.

Different language models may be utilized in different embodiments of the invention, as well as for different processing stages. Language models can vary in size (e.g., small scale with fewer parameters to large scale with large number of parameters), in custody (e.g., within a customer or organization premises, or publicly available and accessible by API such as OpenAI and Azure, etc.), and in domain (e.g., general purpose, specialized, etc.). Considerations for choice of model can include whether a particular model is more suitable for a type of document or business context, or for use of an on-premises or private LM and OCR when data privacy is necessary. One or more routing rules can be used to determine which one or more models to use. Output schemas can match existing business data models. The extracted information may be mapped to normalized, structured business data records.

First are discussed computer architectures that may be utilized for document processing in accordance with embodiments of the invention. Then are discussed techniques for constructing prompts and utilizing LLMs for each of the three processing stages. Finally are discussed processes that integrate the three processing stages into an overall information extraction procedure.

### System Architecture

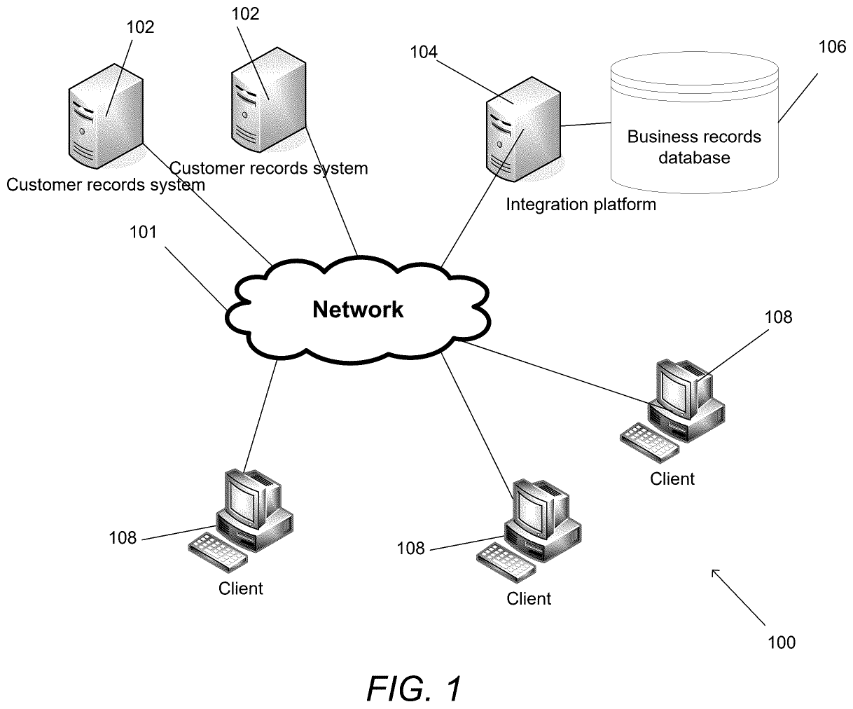

Components of a system for populating a business records database with information extracted from documents in accordance with embodiments of the invention can include software applications and/or modules that configure a server or other computing device to perform processes as will be discussed further below. A system including one or more customer records systems 102, integration platform 104, and client devices 106 communicating over a network 101 as illustrated in FIG. 1. Information in the form of business records data can sent between the integration platform 104 and customer records systems 102. While customer records systems 102 are illustrated as single entities here, it is understood that data sources and data stores be implemented in many forms, such as distributed systems or cloud services. Records provider systems can include Customer Relationship Management (CRM) systems (such as, but not limited to, Salesforce, Zendesk, etc.), Enterprise Resource Planning (ERP) systems (such as, but not limited to, Sage Intacct, Oracle Netsuite, etc.), single sign on (SSO) and identity and access management (IAM) systems (such as, but not limited to, Microsoft and Okta), revenue recognition systems (such as, but not limited to, Revsym, Model N, and Zuora), payroll systems (such as, but not limited to, Intuit and ADP), and vendor management tools, as well as other that provide and mange business information. These can be treated as integration data sources for obtaining records data. The data can be moved using any of a variety of available mechanisms, such as using such as Application Programming Interfaces (API).

The integration platform in turn stores business records data and other information in a database repository 106. Business records data may exist in many different forms and formats and data may be populated by information extracted from documents as will be discussed further below. Systems in accordance with embodiments of the invention can unify business records data to a single format as stored in a database.

Users may access an interface to the integration platform 104 using client devices 108, which can be any of a variety of computing devices, such as personal computers, mobile devices or phones, or tablets. A user interface on such devices can be used for tasks such as to view information, generate reports, and/or send documents to be processed by the integration platform.

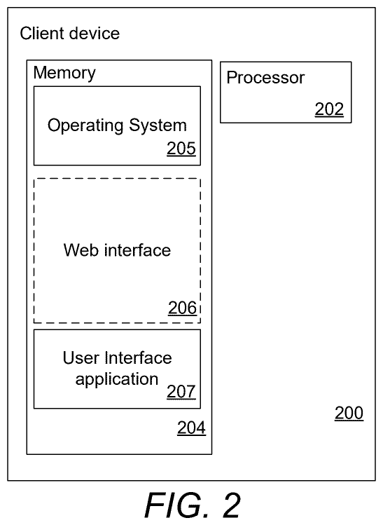

A client device in accordance with embodiments of the invention is conceptually illustrated in FIG. 2. The client device 200 includes a processor 202 and memory 204 that includes an operating system 205, web interface 206 and user interface application 207. The user interface application 207 can configure or direct the processor to perform or execute processes such as those described further below with respect to information extraction rom documents.

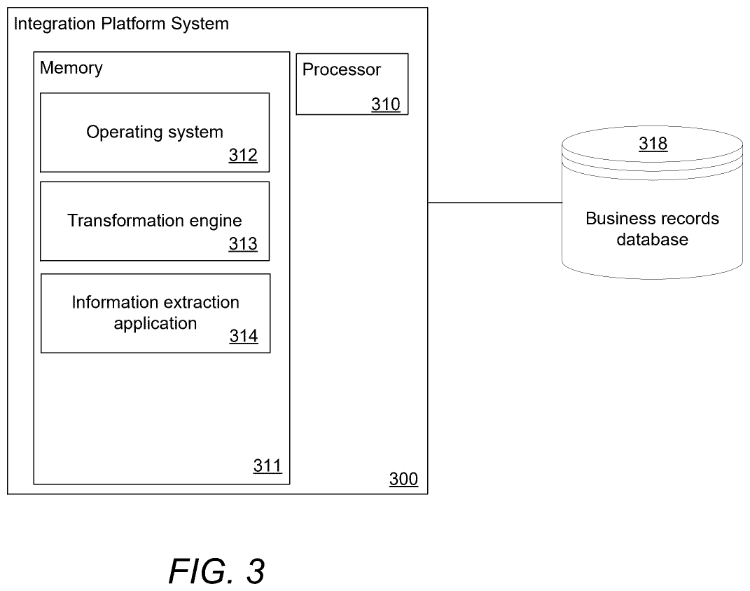

An integration platform in accordance with embodiments of the invention is conceptually illustrated in FIG. 3. The integration platform 300 includes a processor 310 and memory 311 that includes an operating system 312, transformation engine 313, and information extraction application 314. The transformation engine 313 can configure or direct the processor to perform or execute processes such as those described further below with respect to normalizing business records data. The information extraction application can configure or direct the processor to perform or execute processes such as those described further below to extract information from documents. The integration platform can also access a business records database 318 that stores business records data. At least some of the business records data can be populated using information extracted from documents. One skilled in the art will recognize that an integration platform may be implemented using other computing architectures, for example, as a virtual machine, as a cluster of computers, or using a cloud computing service.

Systems in accordance with embodiments of the invention can leverage technologies including natural language processing (NLP), natural language understanding (NLU), and/or optical character recognition (OCR).

Although specific system architectures for populating business records data with information extracted from documents is described above with reference to FIGS. 1-3, one skilled in the art will recognize that any of a variety of architectures may be utilized in accordance with embodiments of the invention.

### LLM Concept and Prompts

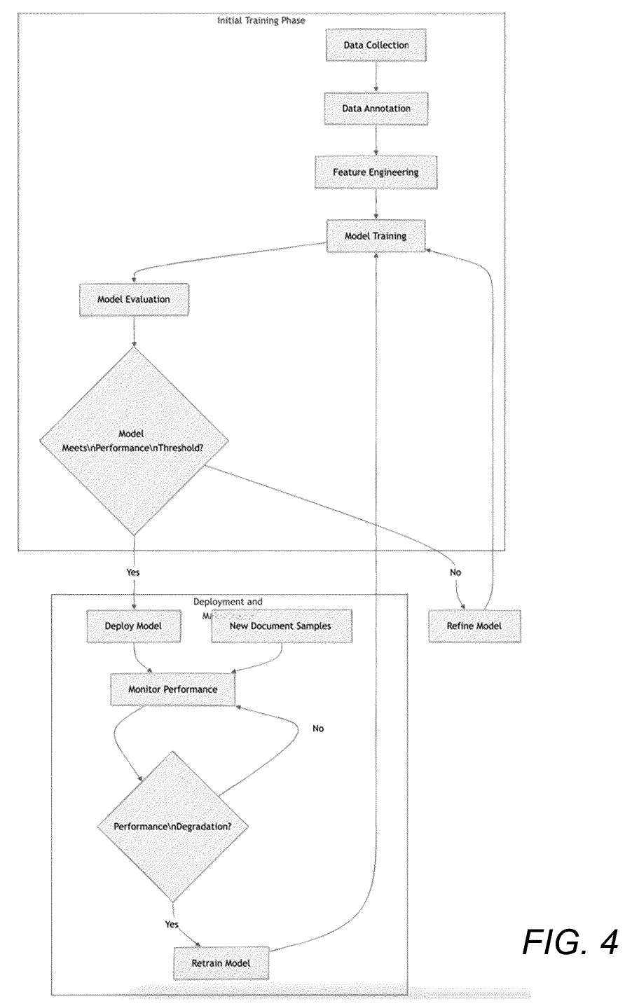

Traditional usage of language models (LM) typically involve a training phase and a deployment and monitoring phase as shown in FIG. 4. In contrast, embodiments of the invention may utilize an approach to constructing prompts in multiple stages or rounds through language models to obtain a desired output of extracting information from complex electronic documents with high accuracy and efficiency. The extracted unstructured information can be transformed into standardized, structured business records.

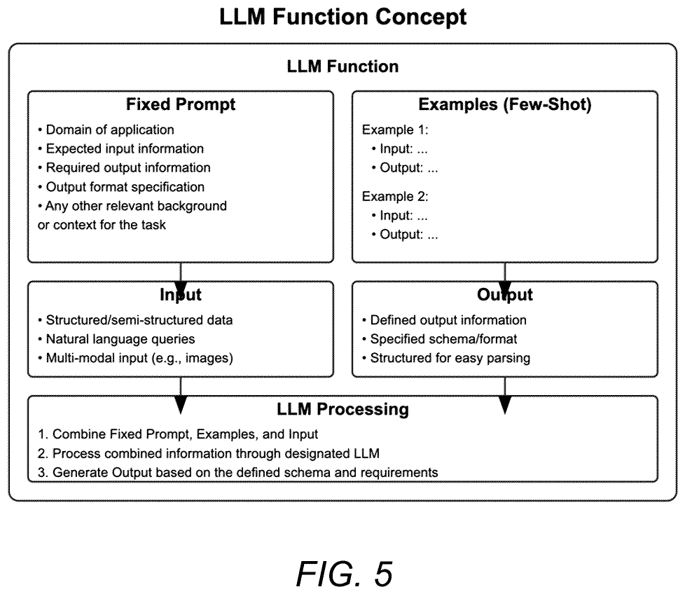

FIG. 5 shows a general approach or template to constructing a prompt for an LLM in accordance with embodiments of the invention. This template may be used for more specific LLM functions in each of the three processing stages discussed further below. Many embodiments of the invention utilize generalized LLMs (i.e., not domain-specific or trained for a specific type of task). Additional embodiments of the invention utilize multi-modal LLMs, which can handle both text and images (and potentially other types of files). A multi-modal LLM can extract and analyze both textual and visual data from documents, providing a more comprehensive understanding of the content. The multi-modal LLM can interpret the structure and organization of information, which is particularly useful for complex documents like forms, reports, or diagrams. It may also be able to identify logos or other visual information (such as color schemes) to get a richer context of the input document. This can be valuable for brand recognition, document classification, or understanding the source and nature of the content.

The elements of a prompt to provide to an LLM can include a fixed portion, examples, and input information. In some embodiments of the invention, the fixed portion used in a particular processing stage can contain information that applies to all documents in that processing stage and be used for all documents. In a few-shot technique, example scenarios can be provided of an example input with a paired example output. The input part of a prompt can include the source document to be analyzed, a portion thereof, and/or a different representation of the source document (e.g., extracted text, image).

The output of the LLM should be provided in a way defined by the prompt. In several embodiments, the output has a specified schema or format as requested in the prompt.

Although a specific template for prompt generation is discussed above, one skilled in the art will recognize that any of a variety of approaches may be utilized in accordance with embodiments of the invention.

### Document Classification

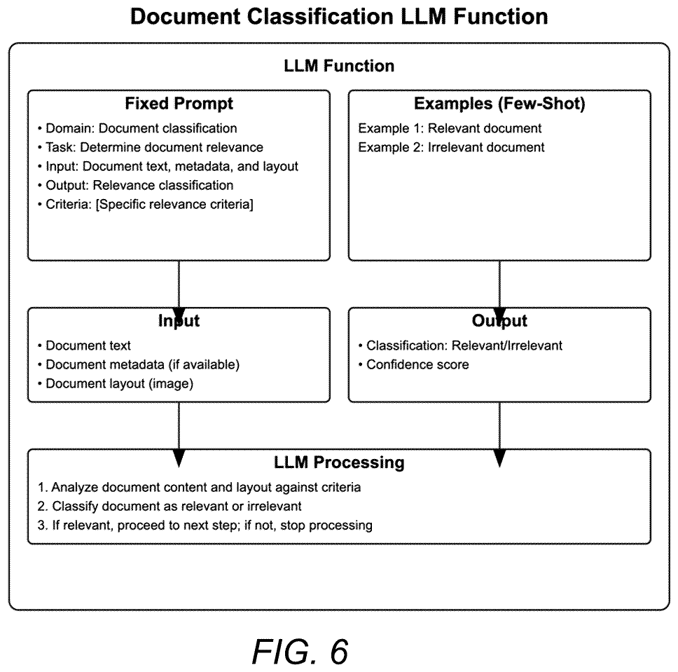

In many embodiments of the invention, a first processing stage of document classification can act as a broad filter to classify a source document as relevant or irrelevant. In later stages, relevant documents can be further analyzed to extract information, while irrelevant documents may be discarded or stored without further analysis. Relevance may have to do with a business records context that the document capture is supporting. For example, if the documents are desired for financial purposes such as accounts payable and accounts receivable, a remittance record would be relevant but a vendor onboarding form would not be relevant. A template for constructing a prompt for an LLM in a document classification stage in accordance with some embodiments of the invention is shown in FIG. 6.

A prompt to an LLM in the document classification stage can include a fixed prompt section that defines the domain as “document classification,” the task as “determine document relevance,” the input as including “document text, metadata, and layout,” the output as “relevance classification” (i.e., relevant or not relevant), and any specific criteria for characteristics of a relevant document (e.g., how it may appear or what it may contain).

In a few-shot technique, examples may be provided of documents that should be found as relevant documents as well as documents that should be found as irrelevant documents.

The input portion of a prompt can include at least a portion or whole of a source document, that is in text and/or an image. The text of a document may be acquired by optical character recognition (OCR) or similar technique. If metadata of the document (e.g., metadata associated with a PDF or other file format that can store associated metadata) is available, it can be included as input as well. In some cases, an image can be more useful because the layout and any company logos can provide additional information to inform the LLM in finding it to be relevant or irrelevant.

An output would be provided by the LLM in response to the input prompt. As defined in the prompt, the output of an LLM in a document classification stage should be a classification of relevant or irrelevant and a confidence score of the classification. If the source document is found to be relevant, it may proceed to a further processing stage. If the source document is not relevant, it may be discarded or may be stored without further analysis.

Although a specific template for a document classification prompt is discussed above, one skilled in the art will recognize that variations are possible within embodiments of the invention as appropriate to a particular application.

### Document Format Detection

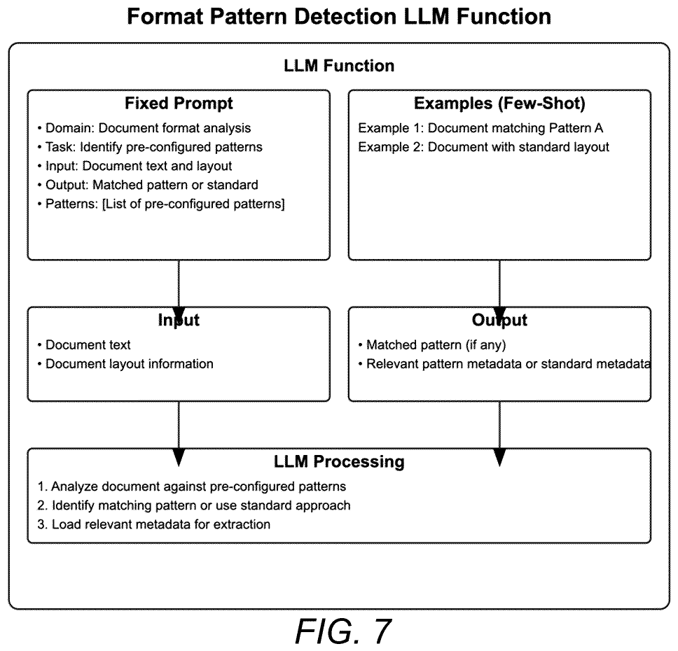

In many embodiments of the invention, another processing stage of document format detection can make an initial analysis of the source document to aid in information extraction. This initial analysis can include determining whether the source document matches a known document pattern. As will be discussed further below, the matched document pattern can have associated metadata and/or other information that aids in extracting information from documents that match the pattern (e.g., match that document type). If there is no match, then a standard document pattern may be used. A template for constructing a prompt for an LLM in a format pattern detection stage in accordance with some embodiments of the invention is shown in FIG. 7.

A prompt to an LLM in a document format detection stage can include a fixed prompt section that defines the domain as “document format analysis,” the task as “identify pre-configured patterns,” the input as including “document text, metadata, and layout,” the output as “matched pattern or standard” (i.e., the document matched a pattern otherwise use standard pattern), and a list of pre-configured patterns for documents. The inclusion of metadata in the input can provide additional context for pattern matching.

Document patterns can include any form of descriptions that provide hints about how documents of that pattern are formatted or what visual elements (e.g., text formatted in certain ways, images, and their locations) they contain. Furthermore, a document pattern may be associated with a document type. For example, invoice numbers usually at top and sum totals are usually at the bottom of an invoice type document. Additionally, a document pattern may be associated with a file type, e.g., PDF, Excel, Word, image, etc.

In a few shot-technique, examples may be provided of documents paired with the pattern that they should be found to match.

The input portion of the prompt can include at least part or whole of input document and may also include layout information (e.g., where items are located within the document).

An output would be provided by the LLM in response to the input prompt. As defined in the prompt, the output of the LLM in a format pattern detection stage should be which document pattern the source document matched (if any). The output may also provide relevant pattern extraction metadata that can help in an information extraction stage, or pattern extraction metadata may be identified separately using the matched pattern. This metadata typically includes information such as the expected location of key fields (e.g., “invoice number is typically in the top right corner”), format of specific data (e.g., “date format is YYYY/MM/DD”), or relationships between fields (e.g., “subtotal plus tax should equal total amount”). In some embodiments, when the source document does not match a pre-configured document pattern, a standard pattern can be used as a “catch all.”

Although a specific template for a document format detection prompt is discussed above, one skilled in the art will recognize that variations are possible within embodiments of the invention as appropriate to a particular application.

### Information Extraction

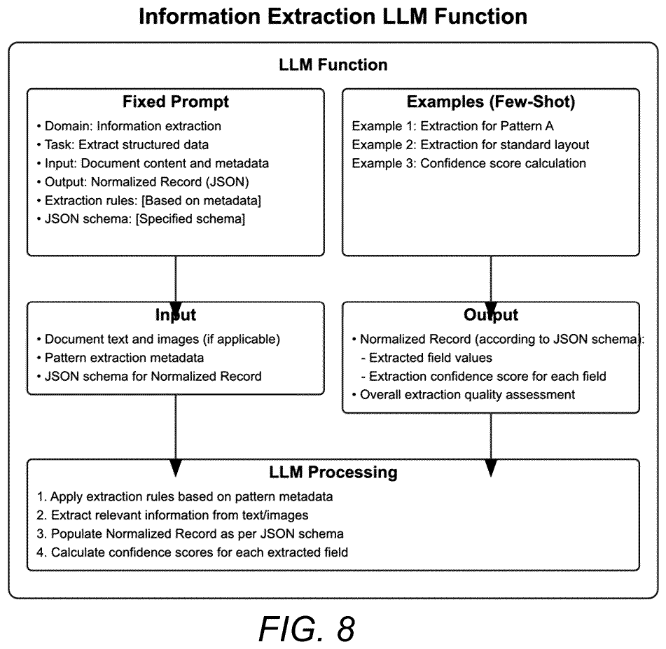

In many embodiments of the invention, yet another processing stage of information extraction can attempt to extract all relevant information from the text and images of the source document. In several embodiments, the extraction is aided by pattern extraction metadata that is identified by a document pattern found to match the source document, such by a document format detection stage as discussed above. A template for constructing a prompt for an LLM in an information extraction stage in accordance with some embodiments of the invention is shown in FIG. 8.

A prompt to an LLM in an information extraction stage can include a fixed prompt section that defines the domain as “information extraction,” the task as “extract structured data,” the input as “document content and metadata,” the output as “normalized record (JSON),” a list of extraction rules based on pattern extraction metadata, and a definition of the schema in which to output (e.g., a JSON schema).

In many embodiments of the invention, pattern extraction metadata provides guidance on how to identify information within a document to extract as field values to populate a JSON format output. For example, to find a field value for “customer name,” the metadata may be an instruction to look for anything that looks like a person's name. To find a field value for “invoice number,” the metadata may be an instruction to look for numbers having a certain number of digits or within a certain range. Additional line items can be stored within a nested structure and/or related to each other, e.g. project start date and end date, due date.

In a few shot-technique, examples may be provided of extraction results for the identified document pattern of the source document, extraction results for a standard pattern, and/or a confidence score calculation (i. e, how a score is calculated).

The input portion of the prompt can include at least a portion or whole of the source document text and/or images and pattern extraction metadata of the document pattern matching the source document.

An output would be provided by the LLM in response to the input prompt. As defined in the prompt, the output of the LLM in an information extraction stage should be a normalized data record (according to the JSON schema in the prompt) having extracted field values from the source document and an extraction confidence score for each field calculated according to the prompt. In further embodiments, an overall extraction quality assessment may be provided. The LLM should apply extraction rules to identify information within the source document with which to populate field values based on the pattern extraction metadata, extract the information from the source document, populate a normalized record with field values from the extracted information per the JSON schema, and calculate confidence scores for each extracted field.

In additional embodiments of the invention, a user may modify the pattern or prompt template by adding a field to the pattern extraction metadata. They may add a description to help find information for the field from within the document to the metadata. The updated pattern extraction metadata may be tested on a source document, and if found successful it can be incorporated for future use.

Although a specific template for an information extraction prompt is discussed above, one skilled in the art will recognize that variations are possible within embodiments of the invention as appropriate to a particular application.

### Processes for Extracting Information From Documents

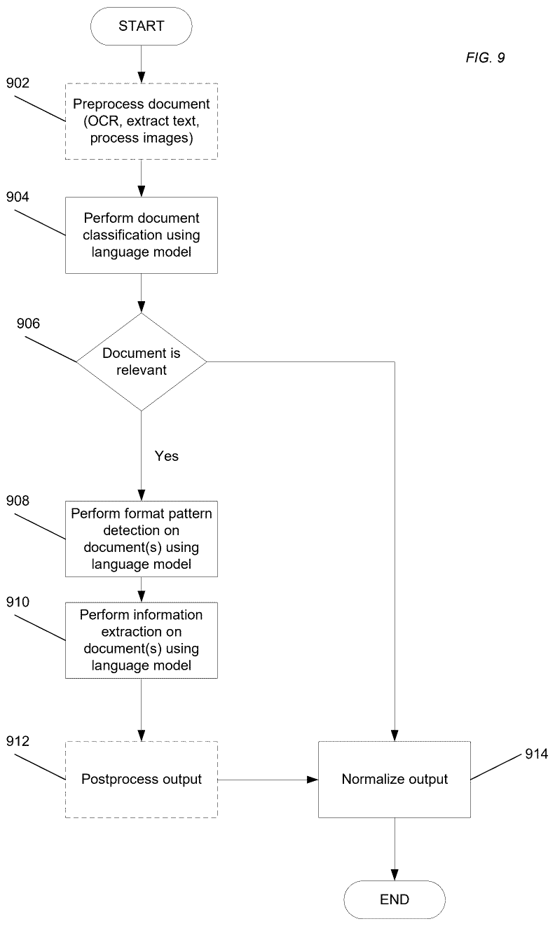

Processes for extracting information from documents in accordance with embodiments of the invention can integrate two or more processing stages using LLMs, such as the stages described above. A process 900 for information extraction using multiple processing stages in accordance with some embodiments of the invention is shown in FIG. 9.

In several embodiments, preprocessing of one or more documents (902) can occur before the LLM processing stages. Text extraction can identify and extract text fields from a source document if it is in a readable text format. If an image of a source document is provided, OCR (optical character recognition) can be performed to identify the text within the source document. Image processing may be performed to determine characteristics of layout of items within the document. Some file formats that may not be suitable as input to an LLM may first be converted to another format that is suitable. For example, data may be extracted from an Excel file and converted into a Markdown file or JSON table, which would be more understandable for an LLM.

In the process, a document classification stage (904) can be performed using a general LLM or another language model (LM). A prompt can be constructed, using a structure and contents such as that described further above and the source document. With the prompt including document text, document metadata, and/or information about document layout, the LLM can output a classification that the source document is relevant or not relevant and a confidence score. In some embodiments, if the source document is found to be not relevant (906), it can be discarded or stored without further processing. If the source document is found to be relevant, it can proceed to additional stages of processing.

A format pattern detection stage (908) can be performed on the source document using an LLM or another LM. A prompt can be constructed, using a structure and contents such as that described further above and the source document. With the prompt including document text and/or information about document layout, the LM can output which pattern the source document matched, if any, and pattern extraction metadata.

An information extraction stage (910) can be performed on the source document using an LLM or another LM. A prompt can be constructed, using a structure and contents such as that described further above, and the source document. With the prompt including document text and/or images, pattern extraction metadata associated with the matching document pattern, and definition of a desired schema for the output, e.g., a JSON schema, the LLM can output a normalized record (according to the specified schema) with extracted field values from the source document and associated confidence scores for each field. Some embodiments also output an overall extraction quality assessment.

In several embodiments, postprocessing (912) can be performed after the LLM processing stages. Postprocessing can include validating the schema of the output, analyzing the output confidence score, and/or additional data cleaning. The output can be normalized (914). Normalization can convert the data into common uniform form, e.g., same format, structure, information types, etc. Techniques for normalizing business records data are described in U.S. Pat. No. 11,615,110, which is incorporated by reference in its entirety.

While a specific process for extracting information from documents is described above, one skilled in the art will recognize that any of a variety of processes may be utilized in accordance with embodiments of the invention as appropriate to a particular application.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

1. A method for extracting and structuring information from electronic documents using language models, the method comprising:
receiving an input document containing unstructured or semi-structured data;
performing a document classification stage by providing a first prompt to a first language model, the first prompt including a fixed prompt section defining document classification parameters, few-shot examples of relevant and irrelevant documents, and the input document, wherein the first language model outputs a relevance classification;
when the input document is classified as relevant, performing a format pattern detection stage by providing a second prompt to a second language model, the second prompt including a fixed prompt section defining format analysis parameters, a list of pre-configured document patterns, and the input document, wherein the second language model outputs a matched document pattern;
performing an information extraction stage by providing a third prompt to a third language model, the third prompt including a fixed prompt section defining information extraction parameters, pattern extraction metadata associated with the matched document pattern, a schema specification, and the input document, wherein the third language model outputs a normalized data record according to the schema with extracted field values and associated confidence scores; and
storing the normalized data record in a business records database.

2. The method of claim 1, wherein the input document is a multi-modal document containing both text and images.

3. The method of claim 2, wherein the first language model, second language model, and third language model are multi-modal language models capable of processing both text and images from the input document.

4. The method of claim 1, further comprising a step of preprocessing the input document prior to the document classification stage, wherein the preprocessing includes optical character recognition when the input document is an image, text extraction, and image processing for layout analysis.

5. The method of claim 4, wherein the preprocessing further comprises converting the input document from a first file format to a second file format suitable for language model processing.

6. The method of claim 1, wherein the relevance classification includes a confidence score indicating a level of confidence in the classification.

7. The method of claim 1, wherein the pattern extraction metadata includes information about expected locations of key fields within documents matching the matched document pattern.

8. The method of claim 7, wherein the pattern extraction metadata further includes format specifications for specific data types and relationships between fields.

9. The method of claim 1, further comprising postprocessing the normalized data record, wherein the postprocessing includes JSON schema validation, confidence score analysis, and data normalization and cleaning.

10. The method of claim 1, wherein the first language model, second language model, and third language model are selected from a group consisting of on-premises language models and publicly accessible language models based on routing rules.

11. A system for processing documents using language models, comprising:
a processor;
a memory coupled to the processor and storing instructions that, when executed by the processor, cause the system to:
receive an input document;
generate a first prompt for document classification including the input document and classification criteria;
send the first prompt to a first language model that outputs a relevance determination;
when the input document is determined to be relevant, generate a second prompt for format pattern detection including the input document and pre-configured document patterns;
send the second prompt to a second language model that outputs a matched document pattern;
generate a third prompt for information extraction including the input document, pattern extraction metadata corresponding to the matched document pattern, and a predefined output schema;
send the third prompt to a third language model that outputs structured data extracted from the input document according to the predefined output schema; and
store the structured data in a database.

12. The system of claim 11, wherein the instructions further cause the system to perform preprocessing of the input document prior to generating the first prompt, the preprocessing including optical character recognition when the input document is an image, text extraction, and image processing for layout analysis.

13. The system of claim 12, wherein the preprocessing further comprises converting the input document from a first file format to a second file format suitable for language model processing.

14. The system of claim 11, wherein the first language model, second language model, and third language model are multi-modal language models capable of processing both text and images from the input document.

15. The system of claim 14, wherein the instructions further cause the system to perform postprocessing of the structured data, the postprocessing including schema validation, confidence score analysis, and data normalization and cleaning.

16. A computer-implemented method for automated document processing, comprising:
preprocessing an input document to extract text and layout information;
constructing a multi-stage prompt-based processing pipeline including a document classification stage that determines document relevance using a language model, a format pattern detection stage that identifies document structure using a language model, and an information extraction stage that extracts structured information using a language model;
wherein each stage utilizes a prompt template comprising a fixed prompt section, few-shot learning examples, and input data specific to that stage;
executing the multi-stage processing pipeline to transform the input document into a normalized business record with extracted field values; and
integrating the normalized business record into a business records database.

17. The computer-implemented method of claim 16, wherein the preprocessing further comprises performing optical character recognition when the input document is an image and converting the input document from a first file format to a second file format suitable for language model processing.

18. The computer-implemented method of claim 17, wherein the language models utilized in the multi-stage processing pipeline are multi-modal language models capable of processing both text and images from the input document.

19. The computer-implemented method of claim 16, wherein the fixed prompt section for each stage includes domain-specific parameters, task definitions, input specifications, output requirements, and relevant background context specific to that processing stage.

20. The computer-implemented method of claim 19, wherein the information extraction stage utilizes pattern extraction metadata that includes expected locations of key fields within documents and format specifications for specific data types, and wherein the normalized business record includes confidence scores for each extracted field value.
